(19) United States
(12) Patent Application Publication
(10) Pub. No.: US 2024/0166443 A1
(43) Pub. Date: May 23, 2024

(54) A TRANSPORT SYSTEM FOR TRANSPORTING AND/OR STORING GOODS WITHIN A STORAGE AND ORDER PROCESSING FACILITY

(71) Applicant: THARSUS LIMITED, Northumberland (GB)

(72) Inventors: Brian PALMER, Stocksfield (GB); David SWAN, East Boldon (GB)

(21) Appl. No.: 18/551,079

(22) PCT Filed: Mar. 16, 2022
(86) PCT No.: PCT/IB2022/052387

§ 371 Date: Sep. 18, 2023

(30) Foreign Application Priority Data
Mar. 16, 2021 (GB) 2103604.1
Jun. 18, 2021 (GB) 2108835.6
Nov. 22, 2021 (GB) 2116808.3

(51) Int. Cl. B65G 1/137; B65G 1/04; B65G 13/02

(52) U.S. Cl. CPC B65G 1/1373; B65G 1/0478; B65G 13/02

(57) ABSTRACT

A system 1 for transporting goods within a storage and order processing facility, comprising a plurality of tile units 2, configured so as to in use form a substantially continuous grid on the floor of the facility; a plurality of substantially flat skid plates 5 configured to locate on top of the grid, each skid plate 5 configured so that a pay load can be placed on the upper surface of a skid plate 5 for transport; the tile units 2 containing drive means 6, 7, 8 configured to move the skid plates 5 on top of the grid; a control system configured to adjust the drive means 6, 7, 8 to alter the position of the skid plates 5 on the grid.

### FIELD

The present invention relates to a transport system for transporting and/or storing goods within a storage and order processing facility. More particularly, the present invention relates to an automated system for transporting and/or storing goods around a warehouse or similar storage and order processing facility.

### BACKGROUND

With improvements in recording the exact location of stock in a storage area, and improved transport and logistics services, it has become more common for suppliers to centralise their warehousing and distribution centres, to store a wider range of goods within a larger, centralised premises, and to ‘pick’ items from the larger stockpile for distribution from the centralised storage area or facility as required. This has led to the rise of ‘just in time’ manufacturing and supply chains.

In older, known warehouses or storage/processing facilities, goods are processed in a roughly linear fashion. Inwards deliveries are unpacked into crates; the loaded crates are placed onto conveyors; and the conveyors carry the loaded crates to shelves, where human “pickers” then take what they need, in order to fill customers' orders.

It is common for goods to be stored and moved in payload carrier such as for example a cage, or on pallets. A number of automated movement solutions are known that assist with increasing throughput, reducing the amount of floor space used, and which provide increased agility and significantly reduce labour requirements.

WO2019/084457 describes and shows an automated carrier system for moving objects to be processed. The automated carrier system includes a discontinuous plurality of track sections on which an automated carrier may be directed to move, and the automated carrier includes a base structure on which an object may be supported, and at least two wheels assemblies that are pivotally supported on the base structure for pivoting movement from a first position to a second position to effect a change in direction of movement of the carrier.

WO2019/175195 describes and shows a conveying module for horizontally conveying units of goods that comprises a base structure for supporting the conveying module on a base, a first conveying device which is designed to convey a unit of goods in a first direction, a second conveying device which is designed to convey a unit of goods in a second direction, the second conveying direction running substantially perpendicular to the first conveying direction, a support structure which is designed to carry a unit of goods, a first lifting device which is designed to raise and/or lower the first conveying device vertically with respect to the support structure and/or the second conveying device between a lower position and an upper position, and a second lifting device which is designed to raise and/or lower the second conveying device vertically with respect to the support structure and/or the first conveying device between a lower position and an upper position. A unit of goods located on the conveying module rests on the support structure when the first conveying device and the second conveying device are in the lower position.

US2019/0100349 describes and shows a transport carrier for transporting goods, that includes a transport carrier structure for carrying the goods in a horizontal plane. The carrier has a top and a bottom side; and a retaining structure arranged on the top side of the transport carrier structure for preventing horizontal movement of goods supported on the transport carrier structure. The retaining structure interacts with bearing elements of the goods and thus causes a reversible fixation of the transport goods along at least one vector parallel to the plane of the transport carrier, such that a force which exceeds a certain threshold level must be expended parallel to the plane of the transport carrier to overcome the fixation.

However, the wide variety and large amounts of goods that are moved around within, into, and out of warehouses to the correct location for storage or on-shipping, has meant that the correct and swift movement of goods has increased greatly in complexity as an issue, and linear processing can in some cases no longer be sufficient or the most efficient way to process goods and orders.

The grids or carrier systems used for these systems can be formed from a number of separate grid elements laid directly adjacent to one another, in a pattern large enough to cover a considerable area of the floor space of a warehouse, with large numbers of cargo carrier units active and moving on top of the grid elements within the perimeter of the grid, carrying cargo trolleys, crates or similar. In order to control the system and for this to work effectively, the individual grid elements need to communicate at least with a control system hub, and preferably also with other elements of the system (i.e. with each other). This is usually achieved via hardwiring/field wiring between the elements.

It is also necessary for the location of the cargo carrying units to be monitored or otherwise known. As these move, these cannot be hardwired, and a general wireless system is also unsuitable as outlined above. It is also often necessary for personnel to enter the grid (i.e. to walk on top of it, inside the perimeter of the grid) in order to carry out routine maintenance on certain areas or within certain boundaries, to replace or remove faulty carrier units, to add or remove cargo from units, etc. It is usually uneconomical and inefficient to shut down the entire operation when these operations are taking place. The personnel are therefore required to enter an active working area with large and heavy equipment moving within it, and the safety of the personnel is therefore a primary concern. It is necessary to maintain the safety of personnel working within the perimeter of the grid, while also maintaining normal operations such as monitoring and moving the cargo carrying units.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY

It is an object of the present invention to provide a transport system for transporting and/or storing goods within a storage and order processing facility which goes some way to overcoming the abovementioned disadvantages or which at least provides the public or industry with a useful choice.

The term “comprising” as used in this specification and indicative independent claims means “consisting at least in part of”. When interpreting each statement in this specification and indicative independent claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

Accordingly, in a first aspect the present invention may broadly be said to consist in a system for transporting and/or storing goods within a storage and order processing facility, comprising: a plurality of tile units, configured so as to in use form a substantially continuous grid on the floor of the facility, the grid comprising a substantially planar upper surface; a plurality of skid plates configured to locate on the substantially planar upper surface, each skid plate configured so that a payload carrier can be placed on the upper surface of the plate for transport; the tile units further comprising a drive means configured to move the skid plates on top of the grid, and; a control system configured to adjust the drive means to alter the position of the skid plates on the grid.

In an embodiment, each tile unit comprises a substantially planar upper surface, and the drive means comprises at least one drive motor unit comprising an upwardly-facing wheel, the drive unit(s) and upper surface configured so that the wheel extends from the upper surface to in use contact the underside of a skid plate.

In an embodiment, the drive means further comprises at least one rotation motor, the drive motor unit(s) in a tile connected to the rotation motor(s) so that the drive motor unit(s) can be turned by the rotation motor(s), from alignment substantially in parallel with one edge axis of a tile to an alignment substantially perpendicular to that edge axis.

In an embodiment, each tile unit is substantially rectangular in plan view and comprises a plurality of drive motor units arranged in a substantially rectangular shape on the tile unit

In an embodiment, the rectangular shape of the drive units is aligned at substantially 45-degrees to the edges of the tile unit.

In an embodiment, the number of drive motor units is eight, arranged so that the rectangular shape of the drive units comprises three drive motor units on each side.

In an embodiment, opposite pairs of drive motor units are counter-rotated.

In an embodiment, the at least one rotation motor and plurality of drive motor units are configured so that substantially half of the drive motor units are directly connected to the rotation motor or motors.

In an embodiment, those drive motor units directly connected to the rotation motor or motors are directly connected one each to one of the unconnected drive motor units, so that directly connected and unconnected drive motor units are paired.

In an embodiment, the system further comprises guide wheels located on the edges of adjacent sides of each tile, the axis of rotation of the guide wheels aligned substantially parallel to the adjacent edge.

In an embodiment, the guide wheels are arranged in pairs of wheels, one pair on each edge.

In an embodiment, the guide wheels and drive motor unit(s) are arranged so that as the tile moves, moving off the point of support provided by a guidewheel or drive motor unit, the tile substantially simultaneously moves onto another point of support.

In an embodiment, the guide wheels and drive motor unit(s) are arranged so that the support provided to the tile is distributed substantially evenly across the underside of the tile.

In an embodiment, each tile unit comprises an upper section and a stationary base section, a lift mechanism located between the upper and base sections, the sections and lift configured so that the upper section can be raised and lowered substantially vertically from the lower section.

In an embodiment, the system further comprises a protective folding screen or curtain that unfolds to extend between the upper section and base section as the upper section is raised and lowered

In an embodiment, the upper section contains the drive means.

In an embodiment, each skid plate comprises a substantially rectangular, substantially rigid item, each skid plate substantially of equal size.

In an embodiment, each skid plate further comprises wheel guides on the underside of the plate, configured to keep the skid plate aligned with the required axis of movement and to compensate for and correct any misalignment of the plate in use.

In an embodiment, one or more of the skid plates and tile units further comprises an interlock assembly configured to mutually interlock the skid plate and tile unit when engaged.

In an embodiment, the interlock assembly comprises at least one depression formed on the upper surface of the skid plate(s), the depression(s) configured to capture the wheel of a payload carrier on the upper surface of the skid plate.

In an embodiment, the interlock assembly comprises four depressions on the upper surface of the skid plate(s), configured to capture the four wheels of a payload carrier on the upper surface of the skid plate.

In an embodiment, the interlock assembly further comprises a plurality of slits formed in the skid plate(s) and a plurality of teeth formed as part of the tile unit(s), the teeth and slits configured for mutual engagement in use so that when engaged, the skid plate is held in position on the tile unit.

In an embodiment, the slits are formed in and through the depression(s).

In an embodiment, the depression(s), teeth, and slits are further configured so that when engaged the teeth extend through the skid plate to a point level with the upper surface of the skid plate, so that substantially the entirety of the upper surface of the skid plate presents a planar surface, the teeth and tile unit configured so that the teeth provide a supporting surface for a payload carrier located on the upper surface.

In an embodiment, the slits are formed in the shape of a substantially square or rectangular matrix.

In an embodiment, the skid plates are substantially square or rectangular, the depressions formed at or towards each corner, the slits substantially aligned with an edge of the skid plate.

In an embodiment, the matrix comprises nine rows, each row of slits substantially three slits long, with three complete slits at each of the left and right sides of the grid of slits and at the centre, the slits formed in a staggered arrangement within the matrix, so that one row is offset from those directly adjacent on each side and each second row is in alignment, part-length slits making up those rows that do not have three full slits.

In an embodiment, the depression extends across substantially the entire width of the shape formed by the slits.

In an embodiment, the depression extends across substantially half of the entire width of the shape formed by the slits.

In an embodiment, the shape formed by the slits is substantially centrally aligned with the depression.

In an embodiment, the teeth are configured so that a front row of teeth extend upwards beyond the upper surface of the skid plate.

In an embodiment, the teeth in the front row slope rearwardly downwards from a higher top front edge.

In an embodiment, the system further comprises a plurality of corner support elements, each corner support element configured to locate under and support a tile corner, the corner support elements configured for attachment to a supporting surface, each of the corner supports configured to engage with up to four separate tiles.

In an embodiment, the corner supports are configured so that when the corner support engages with multiple tiles, the corners of directly adjacent plates are substantially coincident.

In an embodiment, the corner supports are configured so that the corners of four separate tiles engaged with and supported by the support are substantially coincident.

In an embodiment, the corner support comprises two central channels arranged substantially at right-angles to one another and running across the corner support.

In an embodiment, at least one of the corner support elements of the group supporting a particular tile comprises an electrical power connection configured for connection to a power cable installed at floor level, the power connection providing power to the drive means.

In an embodiment, the tile units that form the substantially continuous grid are aligned so that the grid comprises a series of rows and columns, each row arranged straight and in parallel to the other rows, the rows and columns substantially perpendicular to one another, the apparatus further comprising power cables arranged in parallel along substantially the length of each column, the electrical power connections to each tile in a column configured so that tiles are connected to the power supply in parallel.

In an embodiment, the electrical power connections to each tile are made via a trunk and branch format.

In an embodiment, each power cable comprises: a DC+ cable; a DC− cable, and; an earth cable.

In an embodiment, at least one of the corner support elements of the group supporting a particular tile comprises a communication connector configured to send and receive identification signals.

In an embodiment, the identification signals comprise IDs identifying rows and columns in the grid so that an individual tile can calculate it's tile location/address within the grid.

In an embodiment, the communication connector comprises a CAN Bus connector sending and receiving CAN IDs.

In an embodiment, the communication connector is configured to receive safety signals and to disable the drive means in response.

In an embodiment, each tile unit further comprises a cut-out section at two or more corners, the cut-out configured so that a socket is formed at the mutually intersecting corners of any four tiles arranged adjacent to one another with their cut-outs mutually intersecting, each cut-out having a connection section recessed within the socket.

In an embodiment, the system further comprises a plug configured to locate into the socket, the plug and socket mutually configured to provide a power connection between adjacent tiles and to allow data and instructions to be exchanged.

In an embodiment, each tile contains one or more of: a wireless transmitter; a power distribution node; a communication distribution system; a safety distribution system; an RFID reader; a set of scales; a barcode scanner.

in a second aspect the present invention may broadly be said to consist in a skid plate for use as part of an automated apparatus for transporting goods comprising a plate having a substantially planar upper surface, at least one depression formed on the upper surface, the depression(s) configured to capture the wheel of a payload carrier on the upper surface of the skid plate.

In an embodiment, the skid plate(s) comprise four depressions, configured to capture the four wheels of payload carrier on the upper surface of the skid plate.

In an embodiment, the skid plate further comprises a plurality of slits formed in the skid plate(s), the slits passing through the body of the skid plate(s) and configured for mutual engagement with teeth or pins in use.

In an embodiment, the slits are formed in and through the depression(s).

In an embodiment, the slits are formed in the shape of a substantially square or rectangular matrix.

In an embodiment, the skid plates are substantially square or rectangular, the depressions formed at or towards each corner, the slits substantially aligned with an edge of the skid plate.

In an embodiment, the matrix comprises nine rows, each row of slits substantially three slits long, with three complete slits at each of the left and right sides of the grid of slits and at the centre, the slits formed in a staggered arrangement within the matrix, so that one row is offset from those directly adjacent on each side and each second row is in alignment, part-length slits making up those rows that do not have three full slits.

In an embodiment, the depression extends across substantially the entire width of the shape formed by the slits.

In an embodiment, the depression extends across substantially half of the entire width of the shape formed by the slits.

In an embodiment, the shape formed by the slits is substantially centrally aligned with the depression.

in a third aspect the present invention may broadly be said to consist in a tile unit for use as part of an automated apparatus for transporting goods comprising: a regularly shaped box having a substantially planar upper surface; a wheel guide assembly mounted within the box, the wheel guide assembly comprising teeth or pins connected to an actuator, the actuator configured to move the base upwards and downwards in use, the teeth configured to provide a supporting plane with sufficient contact supports to allow trolley wheels to roll across the plane in use.

In an embodiment, the teeth are formed in the shape of a substantially square or rectangular matrix.

In an embodiment, the teeth are elongate shapes in plan view, arranged in rows.

In an embodiment, the teeth are arranged in nine rows, each row substantially three teeth long, with three complete teeth at each of the left and right sides of the grid of teeth and at the centre, the teeth formed in staggered rows, so that one row is offset from those directly adjacent on each side and each second row is in alignment, shorter/part-length teeth making up those rows that do not comprise three full teeth.

In an embodiment, the teeth are configured so that a front row of teeth extend upwards beyond the upper surface of the skid plate.

In an embodiment, the teeth in the front row slope rearwardly downwards from a higher top front edge.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE FIGURES

Further aspects of the invention will become apparent from the following description which is given by way of example only and with reference to the accompanying drawings which show an embodiment of the device by way of example, and in which:

FIG. 1 shows a perspective view from one side looking downwards and sideways of a system according to an embodiment of the invention, the system comprising a number of tiles laid out in a grid on the floor of a warehouse, and a number of skids positioned on top of the grid, the skids and tiles mutually configured so that the skids move on top of the tiles in use to and from positions as required, the skids in use carrying trolleys or similar on their upper surfaces so that as the skids move the trolley is moved to the required location on top of the skid.

FIG. 2 shows a perspective close-up view from one side looking downwards of part of the tile grid of FIG. 1, showing trolleys that have been loaded positioned on top of skids and being moved on the grid for storage, loading and distribution.

FIG. 3 shows a perspective view from above and to one end of the grid, trolleys that are positioned on skids within the grid moving within the grid to required locations so that goods and completed orders can be moved from the pick line through the grid for storage and loading.

FIG. 4 shows a perspective view of the goods-outwards part of the warehouse from substantially the same angle as FIG. 1, showing trolleys that have been loaded as required with completed orders being moved to the exits for loading and distribution on vehicles.

FIG. 5a shows a perspective view from one side looking downwards of an embodiment of static tile unit that forms part of the automated apparatus, the tile having an upper surface with apertures formed therethrough, a number of drive motor units having upwardly-facing wheels that allow movement of a planar skid plate across the top of the tile located below the upper surface, the wheels extending through the apertures, each drive motor unit connected to a rotation motor so that the wheels of the drive motors can be turned by the rotation motor, from alignment with a tile's ‘x’ axis, to alignment with a tile's ‘y’ axis.

FIG. 5b shows the tile unit of FIG. 5a from the same angle, with the top surface removed to show interior detail of the wheels, drive motor units, and the connections between these.

FIG. 6 shows a perspective view from one side looking downwards of an embodiment of skid plate that is used with an array of static tiles such as those shown in FIG. 5, the skid plate formed as a flat, thin, substantially rigid planar body that in use is positioned on top of the tiles.

FIG. 7 shows a perspective view from above and from the same angle as FIG. 5 of a number of the tiles of FIG. 5 laid out in a grid, the edges and corners of each tile directly adjacent to the edges/corners of it's neighbour or neighbours.

FIG. 8 shows the grid of tiles of FIG. 7, with a skid plate as shown in FIG. 6 positioned on top of the grid, the skid plate moveable between tiles, and shown located between two of the tiles.

FIG. 9 shows a stylised plan view of the tile of FIG. 5b, showing detail of the layout of the drive motor units and the connections between these.

FIG. 10 shows a perspective view of the underside of the skid plate of FIG. 6, showing detail of a wheel guide that forms part of the underside of the skid plate.

FIG. 11 shows a perspective view from one side and above looking downwards of multiple tiles laid out to form part of a grid, the edges and corners of each tile directly adjacent to the edges/corners of it's neighbour or neighbours, each tile in this embodiment having a cut-out at each corner, so that an aperture or socket is formed at the mutually intersecting corners of any four tiles arranged adjacent to one another in the grid, the figure further showing detail of an interconnection and communication element or plug that locates into the aperture/socket in use to allow communication and command between the tiles and a central controller.

FIG. 12 shows an embodiment of lifting tile that can be used in the grid where required, the tile containing a scissor-lift mechanism that allows an upper section of the tile to be raised and lowered to and from a stationary base section, a protective folding screen connecting between the upper and lower sections to prevent accidental access to the scissor lift in use.

FIG. 13 shows a perspective exploded view of a tile and skid plate according to an embodiment of the invention, the substantially rectangular skid plate and tile having mutually interacting wheel guide assemblies located towards their corners, the wheel guide assemblies comprising a matrix of slots towards each corner of the skid plate, and teeth/pins that retractably extend from the upper surface of the tile into the slots to hold the tile in position.

FIG. 14a shows a view of the tile and skid plate of FIG. 6, with the skid plate located centrally on the tile, the teeth/pins of the wheel guide assemblies shown in a downwards, undeployed position.

FIG. 14b shows the tile and skid plate of FIG. 14a with the teeth/pins of the wheel guide assemblies in an upwards, deployed position, extending through the slot matrix.

FIG. 15 shows a close-up view of a corner of the tile and skid plate of FIGS. 14a and 14b from the same angle as FIG. 14, with the teeth/pins of the wheel guide assembly of this front corner shown in an upwards, deployed position, extending through the slot matrix.

FIGS. 16a and 16b show close-up views of the front corner skid plate portion of the wheel guide assembly from the same angle as FIG. 15, with the teeth/pins shown in deployed and undeployed positions respectively.

FIGS. 17a and 17b show top and section views of the wheel guide assembly of FIGS. 15 and 16 with the teeth/pins shown in deployed and undeployed positions respectively.

FIG. 18 shows a close-up perspective side view of the tile and a rear corner of the skid plate of FIGS. 13, 14a and 14b from the same angle as FIG. 14, with the teeth/pins of the wheel guide assembly of this rear corner shown in an upwards, deployed position.

FIGS. 19a and 19b show close-up views of the rear corner of the skid plate portion of the wheel guide assembly of FIG. 18 from the same angle, with the teeth/pins shown in deployed and undeployed positions respectively.

FIGS. 20a and 20b show top and section views of the wheel guide assembly of FIGS. 18 and 19 with the teeth/pins shown in deployed and undeployed positions respectively.

FIG. 21 shows a top or plan view of a portion of a grid, three columns and five rows shown, a skid plate shown on each of the five rows, offset downwards from right to left so that from the top of the figure, the plate appears to be moving leftwards along a single row, the plate shown as a line transparency, so that the position of the wheels on the underside of the plate during movement can be seen.

FIG. 22 shows a perspective view from one side and above of an embodiment of corner connector, the corner connector configured to have a central ‘cross’ into which the walls of the tiles can fit at their corners so that four tiles are connected at the junction of their four directly adjacent corners, the corner connector further configured with integral communication and power connectors.

FIG. 23 shows a perspective view of the corner connector of FIG. 22 from the same angle as FIG. 22, showing detail of communication and power cables connected to the corner connector.

FIG. 24 shows a perspective view from one side and above of a 3×3 grid of tiles laid out in a similar manner to that shown in FIGS. 7 and 8, showing detail of the arrangement of corner connectors used to connect each of the tiles, and the power and communication cables that run between these corner connectors.

### DETAILED DESCRIPTION

Embodiments of the invention, and variations thereof, will now be described in detail with reference to the figures.

### System—General

An embodiment of a system for transporting and/or storing goods within a storage and order processing facility is shown in overview in FIG. 1.

As shown in FIG. 1, the system is installed within a warehouse or similar location. In this embodiment the warehouse has a goods-inwards section at one end (to the right of the figure), and a goods-outwards section at the opposite end (to the left of the figure, slightly out of frame and not shown in FIG. 1). Individual goods are shipped from widely-dispersed manufacturing or growing locations to the warehouse, which acts as a central node for storage and redistribution. These goods enter via the goods-inwards section.

The system 1 of the embodiment of the present invention comprises a number of tile units, generally designated with the numeral ‘2’, laid out in a grid on the floor of the warehouse, between the goods-inwards and goods-outwards sections. Each tile unit 2 in this embodiment is substantially the same size as every other, and appears square or rectangular when viewed in plan view, so when a number of the tile units 2 are located side-by-side with one another they form a grid pattern, made up of the individual squares/rectangles of each tile unit 2. In a typical system of this type, the grid will cover a majority of the floor surface of a warehouse, and can consist of thousands of tiles.

The grid in this embodiment covers substantially the whole of the floor surface of the central portion of the warehouse. At the goods-inwards end, the tile units 2 are laid out in a series of narrow ‘fingers’ 3 that extend from the central section of the grid towards the good-inwards doors at that end of the warehouse, with open corridors between the fingers 3. The fingers and corridors lead from the goods-inwards end of the warehouse, towards the main part of the grid in the centre of the warehouse. A pick line 4 extends across the warehouse from one side to the other, substantially perpendicular to the corridors, dividing the fingers 3 from the main part of the grid. The pick line 4 comprises a corridor on the floor of the warehouse that allows users to walk besides the main body of the grid, and the main grid ends of the fingers 3.

It should be noted that the individual tiles allow the grid to be laid out to any shape and size as required for a particular use, by arranging the individual tile units to form a grid of the required shape and size.

The system further comprises a number of skids, generally designated by the numeral ‘5’ (it should be noted that similar numbering is used for variations and different embodiments of skid—numeral ‘5’ designates the general form, and similar numbering such as ‘50’, ‘500’, etc is used in this specification to refer to specific other forms of skid. Similarly, the general form of the tile units are designated with the numeral ‘2’, with similar numbering such as ‘20’, ‘200’, etc used to refer to specific other forms of tile). In use, the skids 5 are positioned on top of the tiles 2 that form the main body of the grid and the fingers 3—skids designated 5a on the fingers 3, and skids designated 5b in the main body portion of the grid (the skids 5a, and 5b are functionally identical, but labelled 5a, and 5b to distinguish location use in this specification). The skids 5 and tiles 2 are mutually configured so that the skids 5 move on top of the tiles 2 in use, as described in detail below. Goods in their original packaging as received are transported into the warehouse on payload carriers such as for example pallets or trolleys, or any other similar type of payload carrier, and are broken down, and/or loaded directly from the payload carriers onto the skids 5 that are on the fingers 3. The skids 5 on the fingers 3 travel back and forth along the fingers, from the payload carriers to the goods-inward side of the pick line 4. ‘Payload carrier’ as used in this specification should be taken to mean any suitable device for carrying a payload, such as the trolleys and cages referred to above, or totes, boxes, packages or similar.

The pick line edge of the main grid body extends along the length of the pick line. A control system activates the tiles 2 to shuffle and move the skids 5a on top of the tiles 2 in the fingers and in the main grid as required. Broken down/unloaded goods are moved along the fingers 3, which are two tiles wide, so that skids 5a on top can move in a loop up one side of a finger 3, and down the other. Skids 5b within the main part of the grid are moved around as required, for loading, movement and short-term storage within the grid, and then on the good-outwards edge for loading onto a vehicle and onwards movement.

Skids on the fingers 3 are loaded directly with goods. Within the main part of the grid, each skid 5b carries a trolley or similar. Skids 5b carrying empty or partly-loaded trolleys are moved to the pick line, where personnel at the pick line receive goods from the skids on the fingers, and load these into trolleys on the skids 5 on the main part of the grid as required. The control system shuffles and moves the skids 5b they are loaded with goods as required. The controller then moves the skids 5b away from the pick line back into the main grid. When a trolley is fully loaded, or is as loaded as is required, it is moved to the opposite side of the main grid, at the goods-outwards end. The trolleys are then unloaded from the skids, and moved out of the main warehouse to a loading dock or similar where they are loaded into vehicles for delivery where required.

The embodiments of tiles that form the grid(s), and the skids that are used with these, will now be described in detail.

### Skid Plate—General Form

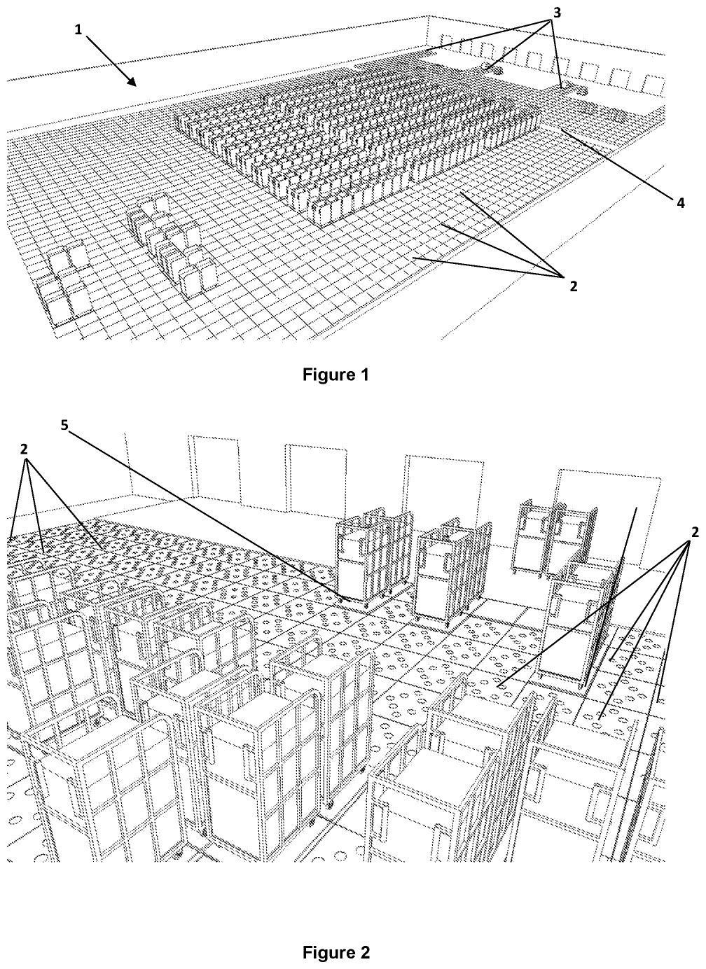

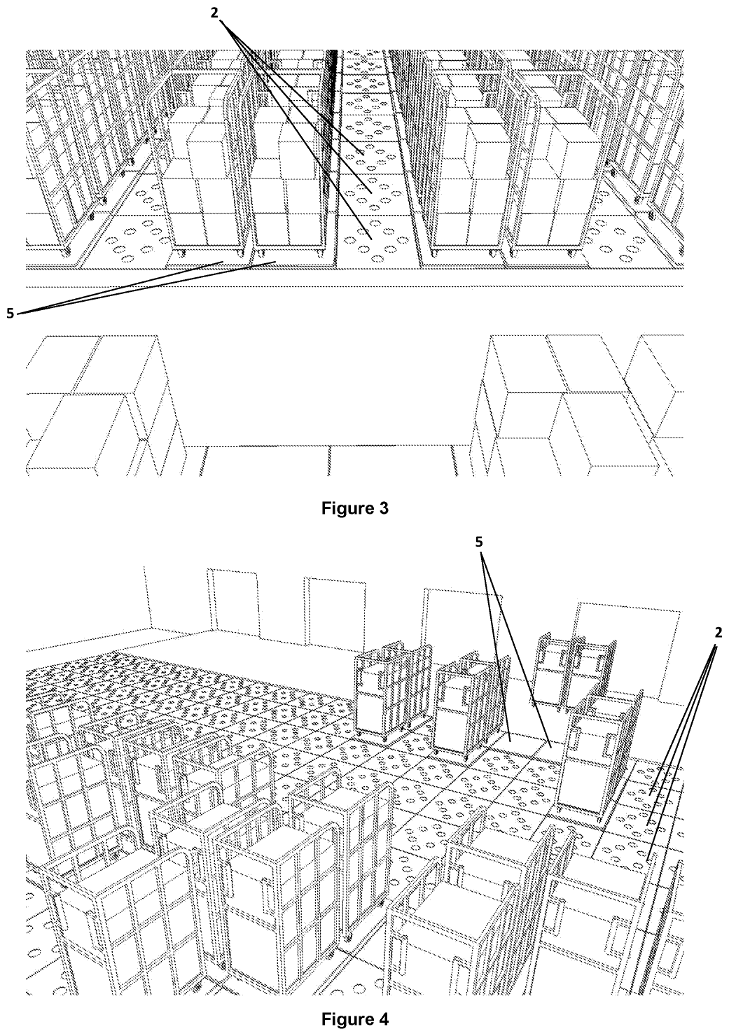

In the embodiment shown in FIGS. 1-4 and 6, the cargo carrier units comprise skid plates 5, which are in direct contact with, and which move on top of, the tile units 2. Goods trolleys 4 or similar items are positioned on top of the skid plates 5 for transport around the grid. The plates 5 are configured to receive the trolleys and transport these.

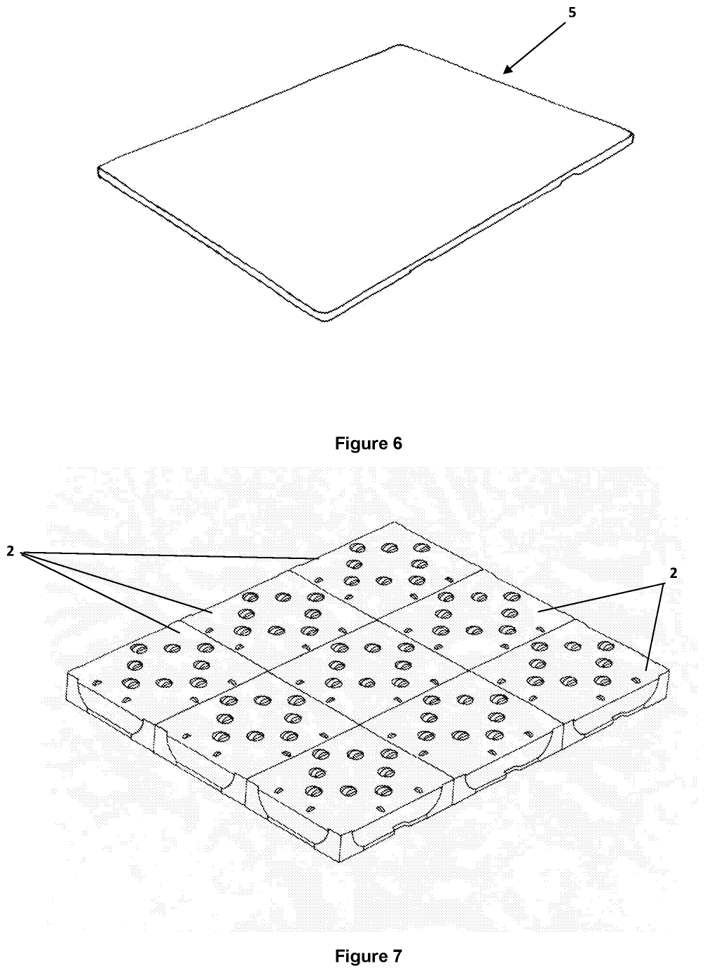

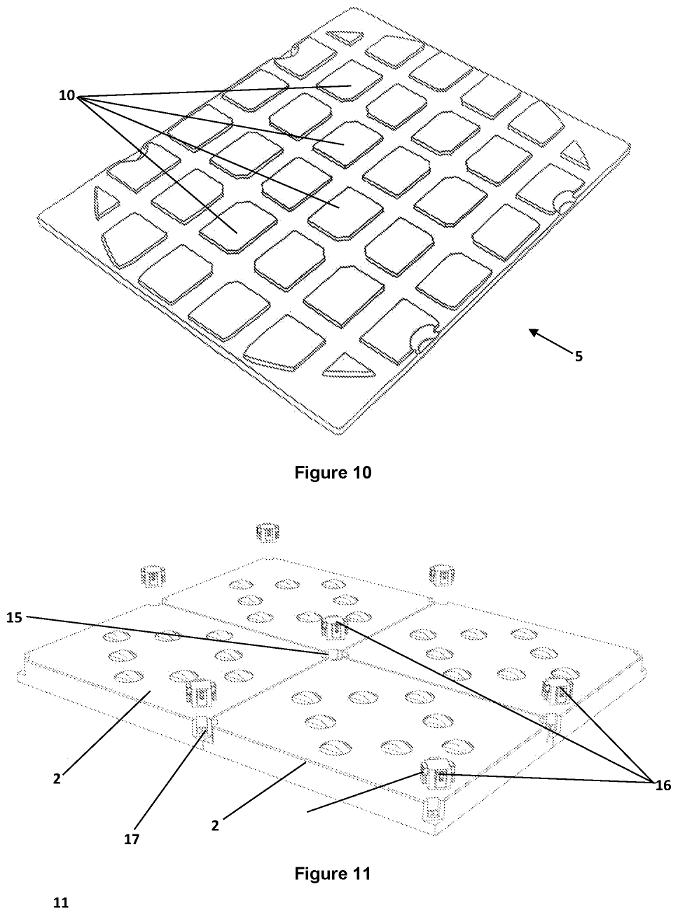

A general form of skid plate 5 is shown in FIGS. 6 and 10. Each skid plate 5 is generally the same size and shape in plan view as the tile unit 2, with a slightly smaller outline so that it can fit entirely within the outline or perimeter of the tile unit 2.

Each skid plate 5 is a flat plate formed from a robust material so that it will not easily bend or break in use. Each skid plate 5 has a number of wheel guides 10 located on the underside, arranged in the shape of crosses that centre on each wheel 7, as shown in FIG. 10. These act to keep the skid plate 5 aligned with the required axis of movement when it first moves off/away from a tile unit 2 on which it is located, and to compensate for any offset in the wheel or power differential from the motors that might cause the plate 5 to become misaligned and to move in slightly the wrong direction at the wrong angle. The wheel guides 10 and wheels 7 are sized and shaped so that the wheels 7 can freely rotate within the centre of the cross formed by the wheel guides 8.

As described above, the skids in the preferred embodiment are substantially the same size (slightly smaller) than the tiles. However, it is envisaged that special-purpose skids could also be used. For example, the skids as described above are ‘1×1’ size. Other sizes such as ‘2×2’ or ‘1×2’ could also be used. It is also envisaged that a larger skid could be formed which could carry all the necessary equipment to be used as a receiving/dispatching office (computers, workstations, etc). This would be a 4×6 or similar-sized skid. Generally, in goods warehouses or similar, the ‘receiving end’ is busier at a particular time of day (morning), and the ‘dispatch end’ is busier at the other end of the day (evening). The ‘office’ skid would move from one end of the grid to the other as required, so that it located closest to the busiest area, in order to assist with management and trouble-shooting.

It is also envisaged that the skid could itself be formed as a container, rather than being a flat plate that carries a container.

### Skid Plate—Interlock Form

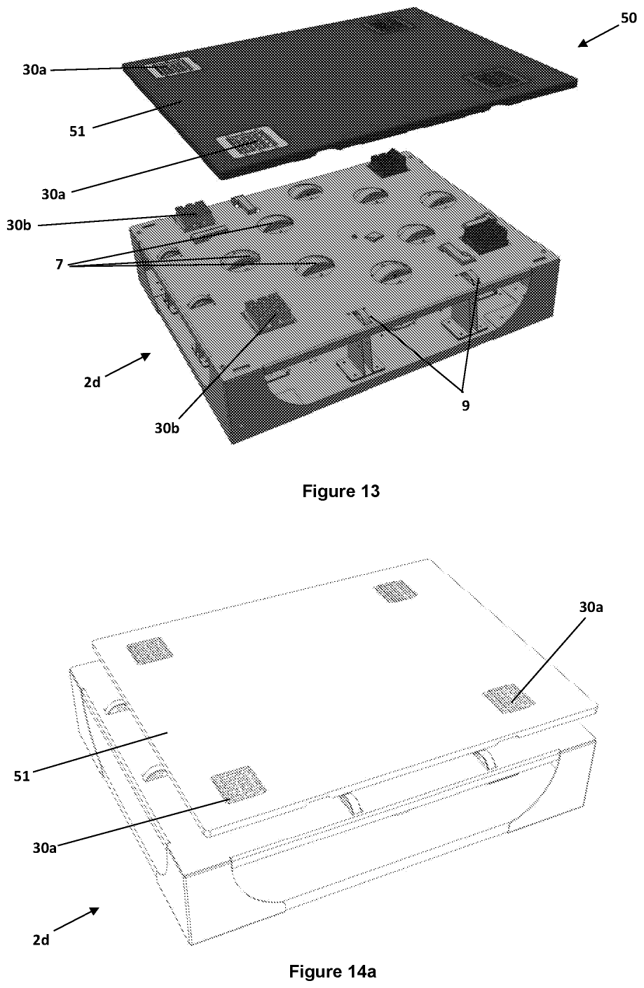

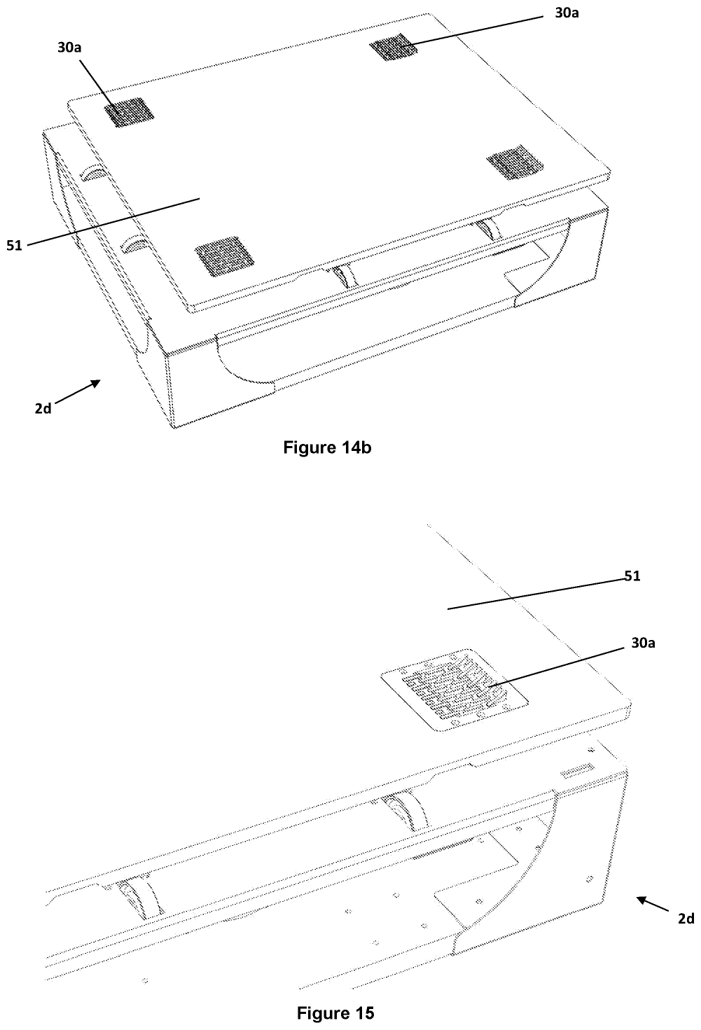

A particular embodiment of skid plate 50 is shown in FIGS. 13 to 15, and will now be described.

Each skid plate 50 is generally the same size and shape in plan view as the tile units 2 or 20, but with a slightly smaller outline so that it can fit entirely within the outline or perimeter of the tile units 2 or 20.

Each skid plate 50 comprises a main body 51 that is a flat plate formed from a robust material so that it will not easily bend or break in use.

A wheel guide assembly is shown in FIGS. 13-15, generally designated as wheel guide assembly 30, and comprising a skid plate portion 30a and a tile portion 30b (portion 30b described in detail below). The skid plate portions or parts 30a of the wheel guide assembly 30 are located towards each corner of the body 51. The skid plate parts 30a of the wheel guide assembly 30 each comprise a grid element that is connected to the body 51 on the top side of the body 51, above/around an aperture formed through the body 51.

Each skid plate 50 has a designated ‘front’ and ‘rear’ edge. Two different types of grid elements are used on each plate 50, at the front and rear edges respectively.

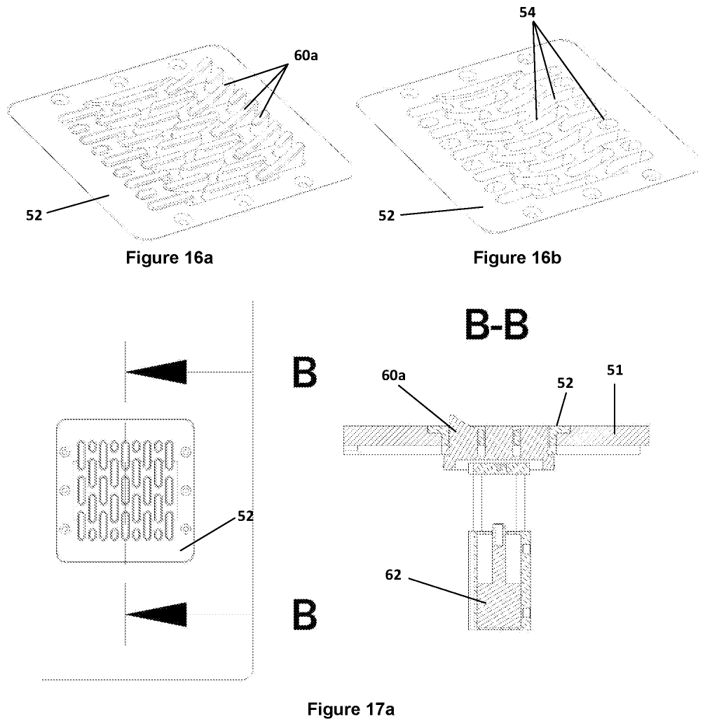

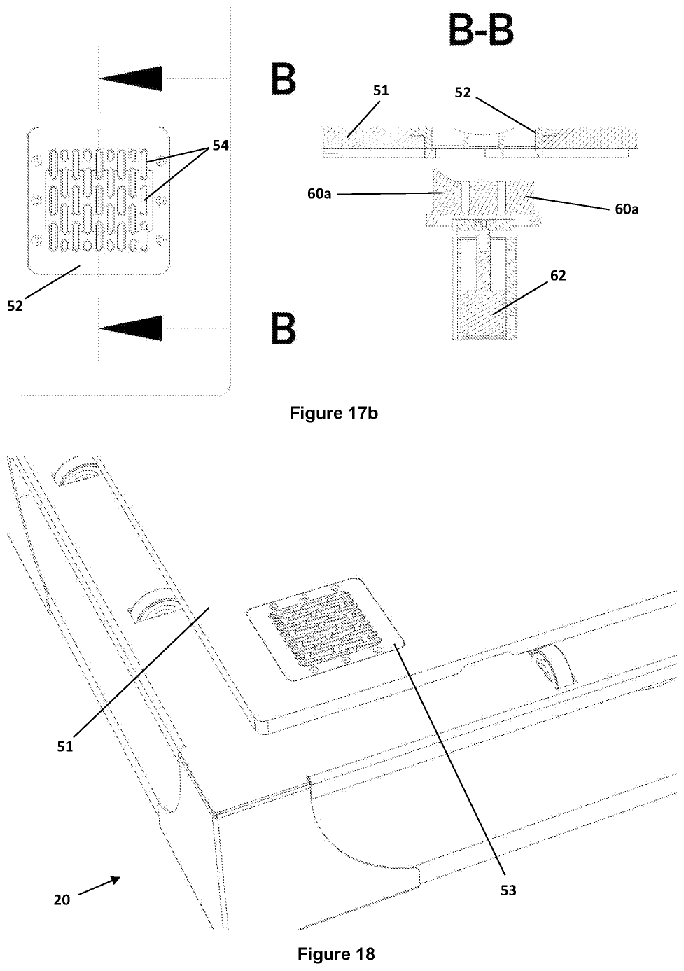

Two front grid elements 52 are used at the front edge, and are shown in FIGS. 16 and 17. Two rear grid elements 53 are used at the rear edge, and are shown in FIGS. 18, 19 and 20.

The grid elements 52 and 53 are similarly sized and shaped in plan view, being substantially square with rounded corners.

A matrix of substantially rectangular slits (slits 54 in grid element 52, and slits 55 in grid element 53) are formed through the centre of the grid element, the slits aligned so that the long axis runs front-rear of the plate 50, the slits substantially perpendicular to the front and rear edges of the skid plate 50. A solid edge portion surrounds the pattern of slits. Each of the grid elements 52 and 53 have three screw holes along each of their left and right edges within the solid edge portion, so that they can be screwed to the body 51 of the plate 50.

In plan view, the slits 54 and 55 correspond in size and shape to the pins 60 on plate 2d, the pins 60 fitting snugly through the slits 54, 55, but without interference or overlap between them that would cause contact friction. When the pins 60 are engaged with the slits 54, 55, the pins extend upwards through the slits to the level of the upper surface of the skid plate 50.

The grid of slits comprises nine rows in the preferred embodiment. Each row of slits is substantially three slits long, with three complete slits at each of the left and right sides of the grid of slits, and at the centre. The slits 54, 55 are formed in a staggered arrangement within the matrix, so that one row is offset from those directly adjacent on each side, and each second row is in alignment.

The slits are arranged to form a roughly square shape in the centre of the grid element, with part-length slits making up those rows that do not have three full slits, so that the front and rear edges of the square shape appear generally straight, rather than jagged/wavy. The square shape formed by the slits is centrally aligned within the square of the grid element.

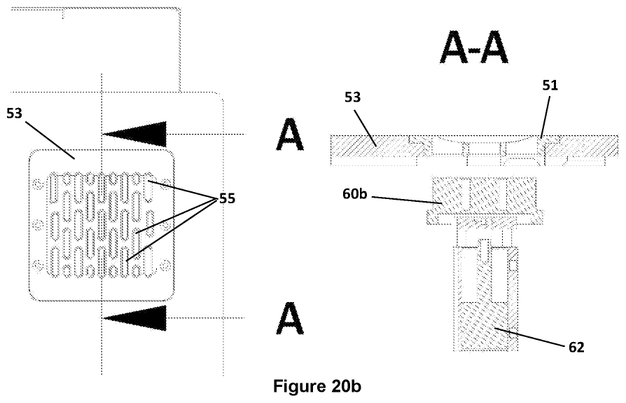

Each grid element further comprises a shallow curved depression across the centre of the grid element. The axis of the circle formed by the curve of the depression runs substantially parallel to the front and rear edges of the body 51. The depression runs substantially the full width (left-to-right) of the square formed by the slits. The depression has a shallow, rounded form, curving gently from the top surface of the grid element. The depression is substantially symmetrical front-rear when viewed as a side-on cutaway, as shown in FIGS. 17b and 20b.

The depression of rear grid element 53, as shown in FIG. 20b, runs substantially the entire width (front-rear) of the matrix of slits 55.

The depression of front grid element 52, as shown in FIG. 17b, has a width (front-rear) of substantially two of the slits 54, and is formed so that it's lowest point is at the mid-point (front-rear) of the matrix.

The position of the grid elements in this embodiment corresponds to the four wheels of a trolley or similar device. The position and the shape of the depressions correspond to the wheels of the trolley, so that the wheels of a trolley rolled onto the skid plate will naturally drop into the depressions and will be captured, or alternatively when a trolley is lowered into the depressions, the wheels are naturally captured. The depth of the depressions ensures the trolley will stay in position when it is subject to the forces induced by the system in use (e.g. movement of the skid plate). However, the depressions are not so deep as to reduce the load bearing strength of the grid elements and skids.

During normal operation, when the skid plate 50 is in position on a tile 2d, and a trolley is being moved on or off the plate, pins 60 from the tile 2d extend upwards through the slits to the height of the main upper surface of the skid plate 50, so that the trolley can be freely rolled on and off the skid plate. When the trolley is in position, the pins 60 are removed (lowered) so that the trolley is lowered into the depressions. The structure and operation of the tile and pins is described in detail below.

The trolley will naturally stay in position within the depressions due to it's own weight/inertia and the force required to push it sideways and upwards out of the depressions during normal use, when the skid 50 is moving across the top of the tiles. During normal use, the wheels are captured and held in place on top of the skid plate 50 without the requirement for tools or special fastenings. The depressions also act to align the wheels in the front-rear direction.

### Tile unit—General

In use, tile units such as tile unit 2 are located onto the floor or similar surface of a warehouse or other storage location, as outlined above. The general principle is that a number of tile units are laid out in a continuous grid pattern, directly side-by-side with one another, in the shape and pattern required—that is, so that a payload carrier such as for example a cage or pallet located on a particular tile unit can be transported across the upper surface of the apparatus 1 via other intervening tile units, to another location within the storage location (e.g. warehouse). The tiles are configured to move the cargo carrier unit via directionally-adjustable wheels or similar that extend through or from the upper surface of the tile. In use, a number of cargo carrier units are active and moving within the perimeter of the grid.

Each tile unit is the same size as every other, and appears square or rectangular when viewed in plan view, so when a number of the tile units are located side-by-side with one another they form a grid pattern, made up of the individual squares/rectangles of each tile unit.

Each tile unit has the general form of a shallow rectangular box with a planar, substantially closed upper surface, as shown in FIG. 6. Variations of tile units make up the grid 1 in an embodiment: a tile 2a that allows movement across it's top surface in both the ‘x’ and the ‘y’ axes; a tile 2b that only allows movement in one of the ‘x’ or the ‘y’ axes (depending on how it is oriented within the grid); a tile unit 20 intended to interlock with a corresponding skid plate, and; a tile 200 that contains a scissor lift that lifts the top part of the tile vertically up and down in the ‘z’ axis.

Where numeral ‘2’ is used in this specification, it can be taken as referring to any one of the different types of tiles. If a specific type of tile is referred to this will be specified by the use of the appropriate numeral—2a, 2b, 20, 200, etc.

It should be noted that although the elements for each tile are described separately, elements can be combined as required. For example, the elements of tile 2a that allow movement in both the ‘x’ and ‘y’ direction can be combined with the elements that make up tile 20 that allow it to interlock with the corresponding skid plate. When a tile unit ‘2’ is referred to, this refers to a general form of tile that has common elements with all the types/embodiments of tile described herein.

Each tile unit 2, such as for example tile 2a, has eight drive motor units 6 within it's square/rectangular (when viewed in plan view) outer perimeter, the top part of the drive motor units 6 protruding through apertures in the upper surface of the main body of the tile unit 2a. The drive motor units 6 are arranged so that in plan view/from above they have the form of a hollow square (three motors in a row on each side), aligned so that the side of this hollow square appears rotated at substantially 45-degrees to the alignment of the side edges of the main body of the tile unit 2a. The ‘hollow square’ is offset towards two edges of the main body, so two corners of the hollow square are at or close to the edges of the main body, and the other two are spaced from the edges.

Each drive motor unit 6 comprises an upwardly-facing wheel 7 that protrudes slightly through an equivalent aperture in the upper surface of the tile unit 2a, so that in use the wheel 7 is in contact with the underside of the skid plate 3 when the skid plate 5 is located on top of the tile unit 2a. When the apparatus is in operation, a skid plate 5 can be moved onto and across the tile unit 2a by operation of the wheels 7.

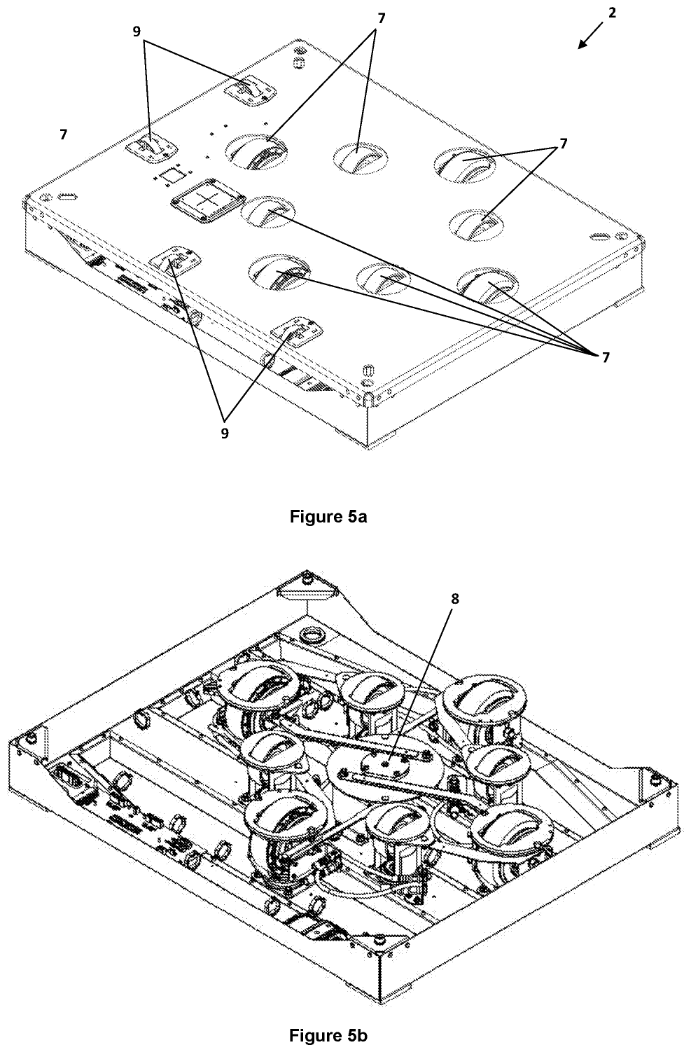

In tile unit 2a, a rotation motor 8 is located at the centre of the square formed by the drive motor units 6. In an embodiment, the rotation motor 8 is a ‘windscreen-wiper’-style motor, or similar. The rotation motor 8 is connected to some, but not all of, the drive motor units 6. In this embodiment, four of the eight wheels are directly driven by the rotation motor 8. ‘Drive wheel unit’ as used in this specification refers to both driven and undriven units. Each directly driven drive motor unit 6 in a tile unit 2a is connected to the rotation motor 8 so that the wheel 7 can be turned by the rotation motor 8 from alignment with one edge of a tile (a tile's plan view ‘x’ axis), to alignment with a perpendicular edge (a tile's plan view ‘y’ axis). This means that a skid plate 5 can be moved onto the tile unit 2a along one axis (e.g. the x axis), and off the tile unit 2a along the other axis (the y axis). In this embodiment, the rotation motor 8 is located at the centre of the square, underneath the square, so that it is not visible from above the tile unit 2a, as shown in FIG. 5.

The drive motor units 6 are mounted on bearing assemblies similar to those used in shopping trolleys, so that they can swivel freely and repeatedly over long periods of use.

In this embodiment, the rotation mechanism does not drive all of the wheels of the drive motor units 6 in the same clockwise/anticlockwise rotation. The default is for opposite pairs (i.e. in the preferred embodiment opposed corners and opposed mid-edge units in the square), to be counter-rotated (rotated in opposite directions to one another) so that the net effect on a skid 5 located on top of the tile unit 2a is as neutral as possible. This keeps the skid 5 central on the tile.

The motor 8, drive motor units 6 and wheels 7 are interconnected as shown in FIG. 9, via connectors 19 and 20. As shown in FIG. 9, four connectors 19 extend from the motor 8, two connectors 19 to two of the drive motor units, and two connectors 19 to two of the wheels 7. The drive motor units are paired, and the wheels are also paired, so that one of the pair is connected to the motor 8 via a connector 19 (and is ‘directly driven’), and the other of the pair is connected to the first one of the pair via a connector 20. In use, as the motor rotates, the connectors 19, 20 rotate the eight drive motor units and wheels between the ‘x’ and ‘y’ axes.

A control mechanism is connected to the grid of tile units 2, to control the motors 8, and to collect information on the contents of the payload carriers that are being moved around by the apparatus 1. The manner in which the tiles and control mechanism are connected will be described in detail below.

Roller wheels 9 are located on two adjacent sides of the tile unit 2, close to the edge of the tile unit 2a. The roller wheels 9 are grouped in pairs, one pair on each of the two adjacent edges, spaced at intervals on the edges. The roller wheels are aligned with a fixed axis of rotation that is aligned in parallel with the edge of the tile unit 2a, and are unpowered. The roller wheels 9 help to guide the skid plates 5 across the tile unit 2a, and to prevent the plates 5 from rotating out of alignment with the axis of the tile unit 2a.

The tile unit 2 also contains a sensor 40. This is positioned on the tile so as to ‘read’ upwards from the upper surface of the tile. The sensor 40 is preferably positioned at substantially the midpoint of that edge of the hollow square that is on the inner side (between the two corners that are spaced from the edges, and not those that are at or close to the edges of the main body). In an embodiment, the sensor 40 comprises a sensor that uses resonant inductive technology to sense movement of the plate over and across the sensor. However, any suitable form of sensor could be used instead, such as for example an optical sensor or similar.

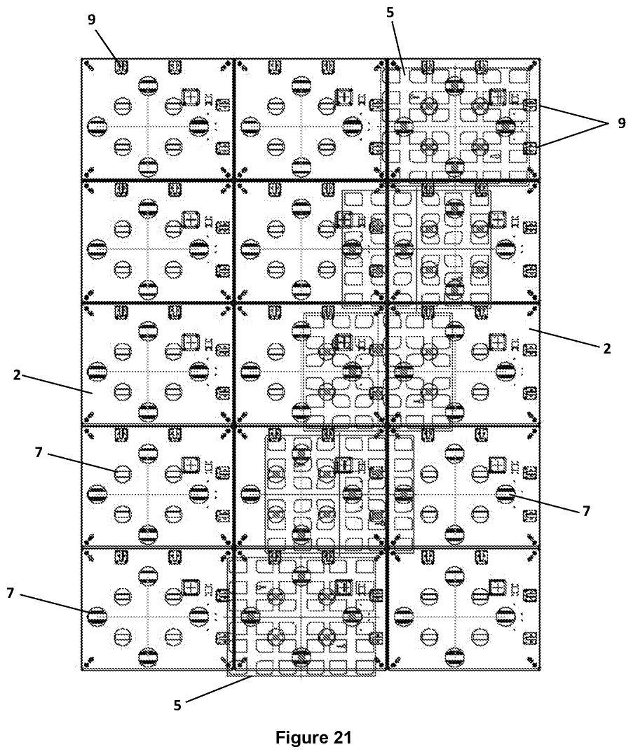

The sensor 40 will trigger when a skid plate moves over it, and off it. As shown in FIG. 21, as the tile moves off one plate and ‘clears’ the sensor on that plate, the tile at the same time starts to move over the top of the sensor on the next plate (see for example the top two rows of the grid in FIG. 21, with the tile moving either left-to-right, or right-to-left).

As the location of each tile in the grid is known (as outlined below), then the location of a particular skid is also known, due to the triggering of the optical sensor. This information can be fed back to a central control system that will move the skids around the grid according to requirements.

Tile 2b only allows movement in one of the ‘x’ or the ‘y’ axes (depending on how it is oriented within the grid). Tile 2b is the same shape and size as tile 2a, and has the same appearance from above. However, in tile 2b there is no rotation motor. The drive motor units 6 drive the wheels 7 in one axis only, so that a skid on top of the tile 2b will only be moved along that axis.

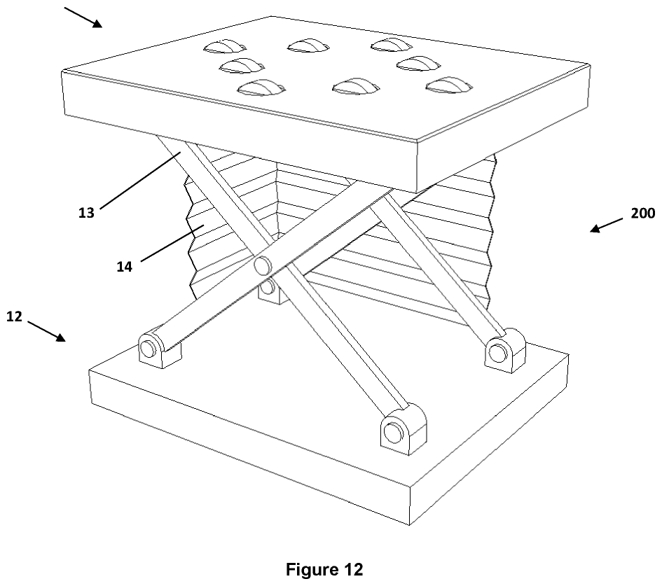

Tile 200 is shown in FIG. 12. The tile of this embodiment has an upper section 11 and a stationary base section 12. A scissor lift 13 is located between, and connects, upper section 11 and stationary base section 12. The scissor lift 13 allows the upper section 11 of the tile 200 to be raised and lowered to and from the stationary base section 12. A protective folding screen 14 connects between the upper and lower sections to prevent accidental access to the scissor lift 13 in use. In the lowest position, the upper section 11 encloses the base section 12. The upper section 11 is the same size and shape as the other tiles described, 2a and 2b, so that it can be connected into the overall grid where required.

The scissor lift allows the upper section 11 to be raised and lowered in the ‘z’ axis. The upper section 11 has the same functionality as either tile 2a or 2b, having drive motors and rotation motors contained within the upper section 11 to drive/rotate the wheels 7. The embodiment of tile 200 as shown does not have roller wheels 9, although these can form part of variations of this tile.

### Tile unit—Pins

An embodiment of tile unit 20 intended for use with a corresponding interlock skid plate 50 (described above) will now be described, with particular reference to FIGS. 13 to 20.

In the same manner as for the general tile unit described above, each tile unit 20 has the general form of a shallow rectangular box with a planar, substantially closed upper surface, as shown in FIG. 13. Tile 20 has substantially the same interior layout as for tile 2a, with each tile unit 20 containing a number of drive motor units that comprise an upwardly-facing wheel 7, the top part of the wheel 7 protruding through apertures in the upper surface of the tile unit 20.

In use the wheels 7 make contact with the underside of a skid plate such as skid plate 50 (described above), when the skid plate is located on top of the tile unit 20. When the apparatus is in operation, a skid plate 50 can be moved onto and across the tile unit 20 by operation of the wheels 7.

Roller wheels 9 are located on two adjacent sides of the tile unit 20, close to the edge of the tile unit 20. The roller wheels 9 are grouped in pairs, one pair on each of the two adjacent edges, spaced at intervals on the edges. The roller wheels are aligned with a fixed axis of rotation that is aligned in parallel with the edge of the tile unit 20, and are unpowered. The roller wheels 9 help to guide the skid plates 50 across the tile unit 20, and to prevent the plates 50 from rotating out of alignment with the axis of the tile unit 20.

As noted above, the tile unit 20 is intended for use with a corresponding interlock skid plate 50. The tile unit 20 and interlock skid plate 50 have parts on each, separately, that together, in use, make up a wheel guide assembly 30. The parts 30a have been described above—skid plate portion 30a.

The tile unit parts 30b of the wheel guide assembly 30 are located towards each corner of the tile unit 20, their location on the tile 20 corresponding to the location of the grid elements 52 and 53 on the skid plate 50, when the skid plate 50 is centrally located on the tile unit 20.

The tile unit part 30b comprises teeth or pins 60 mounted on a base 61.

The base 61 is connected to an actuator 62, the actuator 62 configured to move the base 61 vertically upwards and downwards. In a ‘downwards’ position, the pins 60 are fully below the lower surface of the skid plate 50. In an upwards position, when the skid plate 50 is centrally located on the tile 20, the pins can extend upwards through slits in the plate 50, to engage with the slits.

When the pins 60 are engaged with the slits 54, 55, the pins extend upwards through the slits to the level of the upper surface of the skid plate 50. The skid plate 50 is held in position on the tile 20, and cannot move. A trolley can be freely moved onto and across the upper surface of the skid plate 50, without the trolley wheels being captured in the depressions on top of the skid plate 50. The pins provide a supporting horizontal plane, level with the horizontal plane of the top of the skid plate 50. The pins provide sufficient contact supports to allow the trolley wheels to roll across this plane without the sort of resistance they would encounter from dropping into a depression. The size and staggered disposition of the pins, relative to the size of a trolley wheel, means that the wheel will experience a substantially continuous surface. When the wheels of the trolley are in the correct position, the pins 60 are lowered, so that the wheels of the trolley are lowered into the depressions. The skid plate 50 can then move freely on top of the grid of tile units, from one tile unit to another, until it needs to be moved off the grid. At this point, the pins 60 in whatever tile unit the skid plate is located on are raised up through the slits, to raise the trolley up to the level of the upper surface of the skid plate, so that it can be freely moved across the upper surface of the skid plate and off the skid plate, as required.

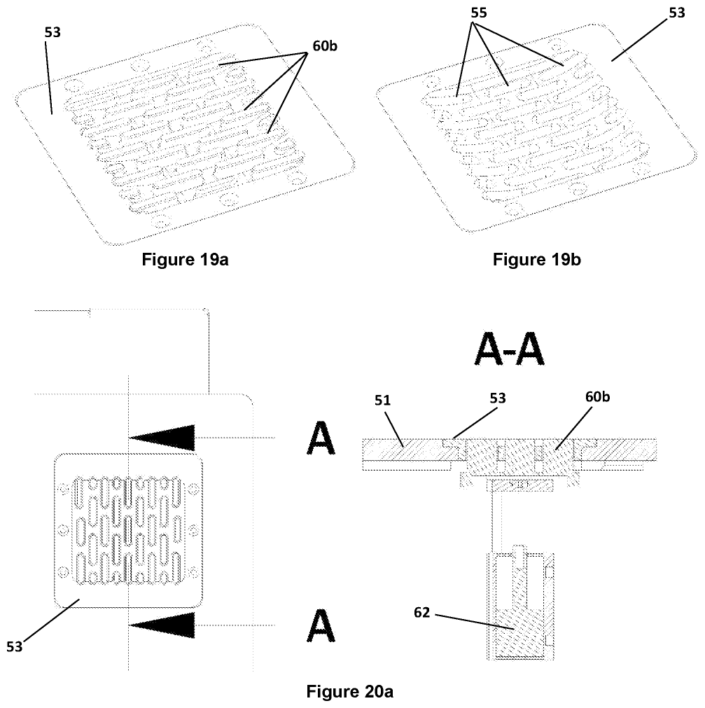

It can be seen in FIGS. 16 and 19 that the pins 60b for the rear grid element 53 all extend to substantially the same height, and have flat, substantially-horizontally-aligned tops. In contrast, the front row of the pins 60a for the front grid element 52 extend higher than those of the front grid element behind the frontmost row. The pins on the frontmost row are shaped so that the top of the pin slopes rearwardly downwards from a higher top front edge.

The pins 60b are flat-topped so that when the pins 60b are in the raised position, the front trolley wheels can move directly over the rear depressions as the trolley is moved onto or off the skid plate 50.

The pins 60a are profiled as described above so that these provide a stop mechanism as the trolley is pushed onto the skid plate 50. They also act as an alignment mechanism. The wheels of the trolley contact the slope of the pins, and in normal use, the slope provides sufficient gravitational resistance to rapidly but smoothly bring the trolley to a stop, without the trolley rolling up and over the pins. The pins 60a also provide an alignment mechanism to ensure that the trolley is sufficiently centred on the skid plate 50.

These protrusions could be formed as a permanent part of the skid plate 50. However, this is not preferred, as this would add to the complexity of the skid plate, and would make it harder to manufacture and also to store (the skids plates could not be stacked on top of each other as easily).

In certain variations of the embodiment described, the wheel guide assembly 30 (the pins and slots) can be modified so as to be used in the same or different locations as guides, acting to move the wheels of a trolley in the required direction. The pins/slots in these variations can be located in other areas other than the corners.

This allows for wheels to be safely guided to the appropriate position on a surface, secured to that surface, release from that surface and guided off the surface all with control and without any of the excess force associated to a wheel dropping into a depression or being driven/forced out.

In further variations, the wheels of a trolley or similar can be driven across the surface by creating a dynamic/rolling wave of pin protrusion and depression to move the wheel across the surface.

In other variations, a wheel guide assembly could also be formed that is suitable for other configurations of trolley, such as a three-wheel trolley.

### Interlock and Communication—Socket and Plug

As outlined above, the tiles 2 are all the same shape and size, and can be laid out in a continuous grid pattern, directly side-by-side with one another, so that the corners of directly adjacent tiles are coincident.

As shown in FIG. 11, in one embodiment, the tile units 2 have a cut-out at each corner, so that an aperture or socket 15 is formed at the mutually intersecting corners of any four tiles arranged adjacent to one another in the grid. As shown in FIG. 11, each socket 15 has an electronic socket connection section 17 recessed within the socket.

In use, an interconnection and communication element or plug 16 locates into the aperture/socket 15 in use to allow communication and command between the tiles and a central controller. Each plug 16 contains a plug connection section 18 that connects with the socket connection section 17, to form a power connection between tiles (to provide power to the motors within the tile), and to allow data and instructions to be exchanged between the tiles and a control system. Each tile contains one or more of various elements, such as for example a wireless transmitter, a power distribution node, a communication distribution system (e.g. location aware V1 CANBUS; UWB/BLE); a power distribution system; a localised safety distribution system (RFID; UWB/BLE), and; an RFID reader.

It can be seen that each individual tile in the grid therefore acts as a link in the overall network. Each tile can establish it's position relative to the others. This helps to minimise infrastructure requirements, and also allows tiles to be swapped out and the grid reconfigured as required. Each tile is ‘plug and play’, and does not need to be configured individually into a unique grid layout. Tiles can be ‘hot swapped’ without need to take the grid offline, or for each new tile (and existing tiles within the grid) to be configured for the new arrangement. The system can also continue to work around a missing tile.

### Interlock and Communication—Corner Support

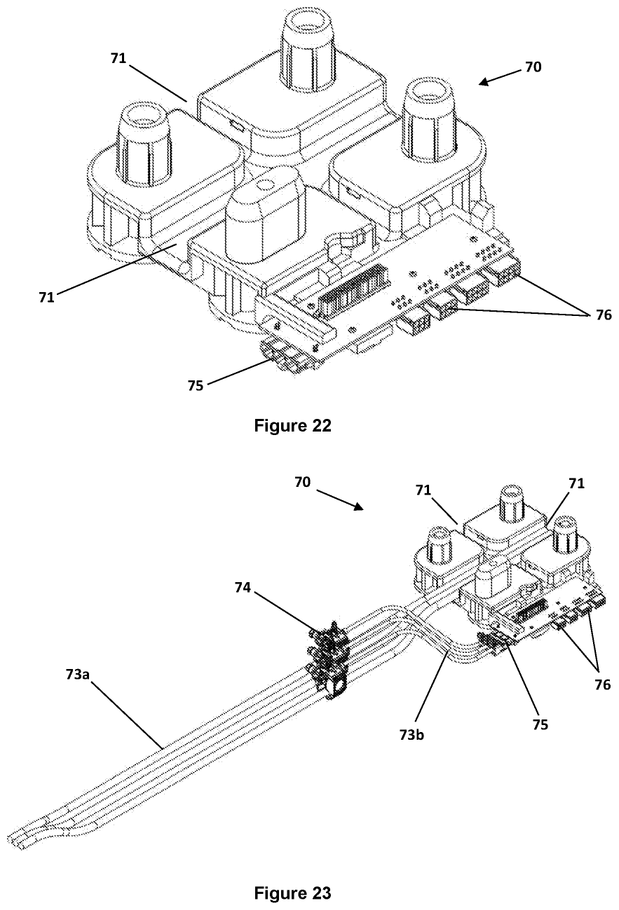

As shown in FIGS. 22 to 24, in another embodiment, the tile units in the grid (directly side-by-side with one another, so that the corners of directly adjacent tiles are coincident) rest on corner supports 70 at each corner. Each of the corner supports 70 is configured to engage with up to four separate tiles—that is, a support in a position away from a grid edge could engage with the adjacent corners of four separate tiles in one location.

In an embodiment, the corner support 70 is formed so that in plan view it has a roughly square outer profile, with two central channels 71 sectioning the corner support into four roughly equally-sized sections, the central channels 71 arranged at right-angles to one another and running across the corner support from the mid-point of one side to the other.

The corner supports 70 provide support to the tile(s), mechanical alignment between tiles, and are used to connect power and to provide connections to tiles for communications and safety signals, as described below.

As outlined above, each tile rests on four corner supports, one at each corner. In the centre of the grid, away from the edges, the corner supports are ‘shared’ between up to four tiles, the corner of a single tile slotting into the channels 71 so that one quarter-section of the corner support 70 is enclosed by the walls of the tile.

In use, the corner connector is fixed to the floor of the warehouse (or similar) by adhesive. The corner connector 70 will not move in use, as it is fixed to the floor. However, the body of the corner connector 70 can expand and contract with movement of the tiles 2 that are slotted onto it (as the tiles themselves move and expand and contract due to for example temperature changes and similar).

In a given arrangement, one of the four corner supports 70 for each tile is configured with electrical power connections 72. The remaining three corner supports provide support and alignment only. The power connections are made with cables 73 installed at floor level with the corner supports. Connections are provided in a trunk and branch format such that each ‘power’ corner support 70 provides a connection to a tile, and tiles are connected to the power supply in parallel. In this way the removal of a tile from the grid does not disturb the power supply to other tiles.

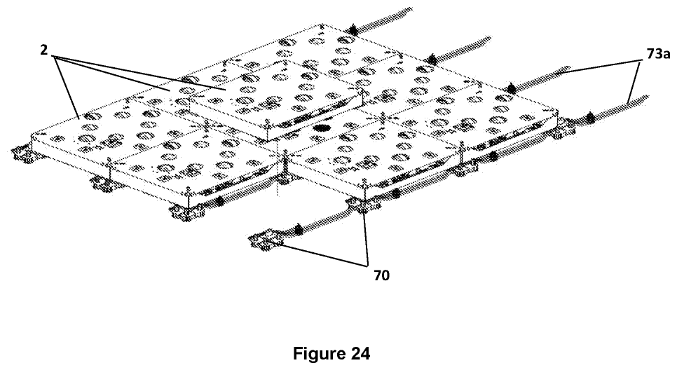

As shown in FIGS. 23 and 24, the main ‘trunk’ cable 73a runs the length/height of a full column of the grid, with power for an individual connector ‘taken off’ this main cable via a ‘branch’ connector 73b, that connects to the main ‘trunk’ cable 73a via a connector 74, and which connects to the corner connector via a power socket 75. In this way, the failure of a connection to a single tile does not mean that the entire column is inoperative—only the single tile. Power can still pass along the main ‘trunk’ cable 73a to the other tiles in the column.

Cable 73a in this embodiment comprises three cables—a DC+ cable, a DC− cable, and an earth cable. Each of these is connected to the corner connector via the cable 73b, connector 74, and power socket 75.

In this embodiment, communications between tiles and a control system is via CAN Bus. The CAN Bus connection is made through the communication sockets 76.

In use, the tiles are laid out in a grid, as shown in FIG. 24, so it can be seen that there are discrete rows and columns. Suitable identification signals can be sent through each of these connections—a first ‘row’ CAN ID for the row CAN bus and a second ‘column’ CAN ID for the column CAN bus). These IDs can be treated in a similar manner to ‘x’ and ‘y’ co-ordinates so that an individual tile can calculate its own location/address within the network.

Pre-configuration of tiles is therefore not required. Tiles can be hot-swapped, picking up their power, data connections, and identity via the corner connectors upon insertion into the grid.

Safety signals can also be sent in a similar manner via the corner connectors. In this embodiment, the safety signals are ‘Safe Torque Off’ (STO) signals that act to disable the moving parts of the tile (e.g. the drive motor units 6) to make it safe. The grid-wise arrangement of the tiles allows for these signals to be sent to specific tiles or groups of tiles so that these can be made safe, by selecting the appropriate combinations of STO signals for columns and rows within the grid, to activate/deactivate tiles within the grid. This allows for individual tiles and sub-section(s) of the grid to be made safe (moving parts prevented from activating) whilst leaving the remainder of the grid active.

Further forms of tile are also envisaged, such as ‘no axis’ or ‘blank’ tiles, that are used as power or communication nodes. These can be located at the corners of the grid. If required, corner and edge tiles can also be configured to help prevent tripping, for example by having an edge slope and/or safety marking.

Tiles can also be fitted with barcode scanners, scales, or other similar devices, in order to assist with tracking items within the storage location.

It is also envisaged that some types of tiles can be fitted with turntables or similar to allow directional changes for devices on top of the tile, where a change in travel direction between the ‘x’ and ‘y’ axes is insufficient. These could be used, for example, at the goods-out end of the main grid, to turn the skids around so that cages or similar on the skids are facing in the preferred orientation for loading onto trucks.

Tiles fitted with robot arms are also envisaged, for automatic picking. These would locate where required within the grid, and would pick items from the contents carried by adjacent tiles as required. Both the tiles fitted with robot arms, and the tiles from which they are picking, could be moved as required within the grid by the controller.

### Communication

At least some and preferably all of the tile units 2 are configured so that they can communicate with a central control system. The control system provides instructions to the tile units, and receives status updates and similar information back from the tiles in return. In this embodiment, the tile units 2 are also configured so that they can communicate directly with other tiles 2—at least the tiles directly adjacent to themselves. This allows them to co-ordinate their actions with each other directly. Items on top of the grid (cargo carrier units), are moved around the grid through the cooperation of multiple tiles working in a coordinated manner to route items from one tile to another, so that in overall operation items are moved from a source to a destination.

In order to function, the control system needs to ‘know’ where each tile is within the overall grid, and from this, which tiles any particular individual tile is physically adjacent to. The control system also needs to ‘know’ what each tile is doing/what action the tile is undertaking at any particular time. The control system requires this information in order to be able to send the correct instructions to a tile, so that the tile carries out the correct action at the correct time—e.g. moving an item across its surface in a particular direction.

This means that physical tile locations and their logical tile address (for information routing purposes), must be known.

The known, prior art, approach to communication between elements within the system is usually some form of field-bus wiring, such as for example EtherCAT, Profibus, Modbus, RS485, CAN Bus etc. The two main issues with field wiring are: the amount of cabling required (which can total thousands of metres), and the complexity of managing multiple discrete data-buses (which can number several hundred in a typical installation).

As outlined above, the tiles 2 are arranged into a grid, with CAN Bus connections made through the communication sockets 76. Suitable identification signals can be sent through each of these connections—a first ‘row’ CAN ID for the row CAN bus and a second ‘column’ CAN ID for the column CAN bus). These IDs can be treated in a similar manner to ‘x’ and ‘y’ co-ordinates so that an individual tile can calculate its own location/address within the network. This helps to reduce the amount of cabling.

### Use

In use, the grid is laid out into the required configuration, such as the grid 1 shown in FIG. 1.

The tiles 2 are connected as required to form the overall grid, with tiles 2a, 2b, 20 and 200 (or tiles that are combinations or variations of these, or any other suitable type of tile) used as required to form various portions of the grid. The tiles and the plugs 16 enable communication between the tiles and a central control system. Power, communications and safety all link into and out of every tile in a way that ensures that no single tile can be a critical failure point—that is, if one single tile fails as a communications and power node, then communications and power can be routed around it, via for example the adjacent tiles, and it can be bypassed until such time as it can be repaired or replaced.

Each of the tiles can be positioned in the grid as required for a particular overall configuration of the grid. For example, in the configuration shown in FIG. 1, there are ‘fingers’ 3 that extend from the main body of the grid 1 towards the goods-inward doors of the warehouse. The control system will move the skids 5a in a loop around the finger 3 on which they are located, from the end closest to goods-inwards, to the pick line end. This allows the skids 5a to be loaded and unloaded. It can be seen that there is no real need for the tiles within the main length of the finger to have movement functionality in both the ‘x’ and the ‘y’ directions. It is enough for these to have basic functionality in a single axis, and therefore tiles 2b can be used, with dual-axis movement tils 2a used at the outer and inner ends of the finger 3 to allow the skids 5a to move across from one side of the finger to the other.

It may also be desirable to have tiles 2c located at one or more positions on the finger/fingers 3. Raising the height of the upper surface of the tile allows a user within the warehouse to load or unload boxes, crates or similar items onto the upper surface more easily, without bending down.

The control system will move the skids 5b along the to the pick line so that a user can load a trolley as instructed. Once loaded, the skid 5b will move back into the main body of the grid for temporary storage, or to move to the goods-outward edge of the main grid, for loading onto a truck or similar.

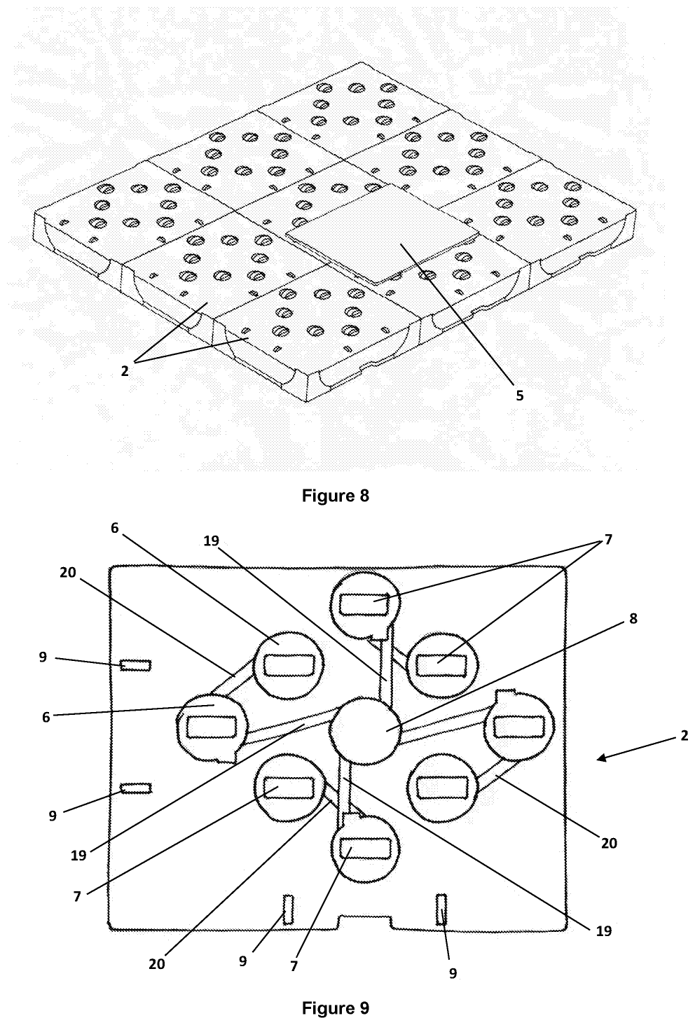

Movement of the skids 5 on the tiles 2 is via the wheels 7 and motor units 6. The control system activates the motor units 6, so that a skid plate 5 will be moved to the required location, the skid plate 3 rolling over the tile units 2 as shown in FIG. 8, the control system sending instructions to activate the motors to move the skid plate 5, by moving it in the ‘x’ and ‘y’ directions alternately, from one tile 2 to another, so that it's path consists of a series of straight lines in the ‘x’ and ‘y’ directions until it reaches it's destination.

An example of a skid moving on top of the tiles is shown in FIG. 21. The portion of the grid shown in FIG. 21 comprises three columns, each of five tiles (a 3×5 grid as shown in FIG. 21). A tile is shown on each of the rows, in the top row shown on the far right, and in a central position on the bottom row, the three rows in between showing the tile ‘moving’ from right-to-left between the two positions, from top to bottom.

The tile in this figure is shown as a line-transparency, so that the position of the wheels 7 and roller wheels 9 can be seen, in relation to the underside of the skid.

Those wheels and roller wheels that are underneath and supporting the skid are shown as solid elements in the figure.

As can be seen, the tile and skid are configured so that as the tile moves off each ‘point’ of support, it moves onto another at the same time.

For example, if we compare the top row and the second row down, as the tile moves off the rollers 9 to the right, it moves directly onto the rollers on the tile to the left. As the tile moves off the wheels 7 to the right, it moves onto the wheels on the tile to the left.

The tile will always be supported by multiple points of contact as it moves, these points of contact distributed across the underside of the tile, with the edges and corners always supported, so that the tile will not tilt as it moves, and the edge will not ‘dig in’ and potentially tip the load.

The main body of the grid is in most embodiments comprised of a mix of different types or variations of tiles. It is most preferred that ‘lanes of travel’ are formed in the main body of the grid—that is, lines through the grid from one end to the other (or from side-to-side) that allow the direct passage of skids and their loads. This can be for the purposes of moving loaded skids by the fastest and most direct route—e.g. straight from the goods-inwards end of the grid to the goods-outwards end—that is kept clear so that there is no need to move any skids that would otherwise be blocking their path. These lanes only require movement in a single axis, and so can be formed from 2b-type tiles. The use of these lanes reduces cost and helps to increase reliability.

The main ‘storage’ areas of the grid, where unloaded skids and/or loaded skids are located when not required, can be formed from a mix of tiles of the 2a and 2b types, so that skids can be moved around in both the ‘x’ and ‘y’ axes into and out of these areas, and within these areas. These sub-sections of the grid, and the overall grid itself, can be formed from a mix of the different types of tiles 2 as required.

The controller and the grid are further configured so that personnel can safely move on the grid as required. The controller can remove or ‘blank out’ certain tiles from the grid as outlined above, to allow people to move to those blank spots on the grid to carry out maintenance or similar. This can be achieved using a standard STO (Safe Torque Off) function in the motor drives as outlined above. This allows scenarios where only a small area of the grid is required to be shut down, and the rest remains running around the shut-down area (for example, if a skid gets stuck, if part of the load falls off, etc). Making each tile individually addressable is complex, and to isolate a “line” of them will always bisect the grid and make it impossible to effectively use the balance of the grid. Therefore, as outlined above, each tile in the grid is attached to two safety input connections, one for the vertical group and one for the horizontal group. By using “OR gate” electronics in the tile, an operator can select a discrete group of tiles that can be switched off by removing the appropriate vertical inputs and horizontal inputs. All cells (tiles) within the grid losing both lines (vertical and horizontal) will cease functioning, but all other tiles (that lose none or just one of the safety inputs) will continue to work as normal. This provides a simple but highly granular safety isolation system that will ensure safety but maximise grid uptime.

Further isolation of the grid can be achieved as necessary. For example, rather than a pick line as in the embodiment described above, isolated islands could be formed in the main grid that allow skids to be moved around, but not into and across, certain locations. These locations can then be used by pickers, with skids moving so as to ‘present’ at the perimeter of the island.

The elements described above can be used to build a flexible system that can be reconfigured as needed in order to deliver the functionality required, and which.

For example, the control system can generate reports on the usage of each individual tile within the grid, and tiles that are being over- or under-utilised can be identified, and moved and/or the grid reconfigured, as required.

1. A system for transporting and/or storing goods within a storage and order processing facility, comprising:
a plurality of tile units, configured so as to in use form a substantially continuous grid comprising a substantially planar upper surface;
a plurality of skid plates configured to locate on the substantially planar upper surface, each skid plate configured so that a payload carrier can be placed on the upper surface of the plate for transport;
the tile units further comprising a drive means configured to move the skid plates on top of the grid;
a control system configured to adjust the drive means to alter the position of the skid plates on the grid.

2. A system as claimed in claim 1, wherein each tile unit comprises a substantially planar upper surface, and the drive means comprises at least one drive motor unit comprising an upwardly-facing wheel, the drive unit(s) and upper surface configured so that the upwardly-facing wheel extends from the upper surface to in use contact the underside of a skid plate such that rotation of the upwardly-facing wheel alters the position of a skid plate on the grid.

3. A system as claimed in claim 2, wherein the drive means further comprises at least one rotation motor, the drive motor unit(s) in a tile unit connected to the rotation motor(s) so that the drive motor unit(s) can be turned by the rotation motor(s), from alignment substantially in parallel with one edge axis of a tile unit to an alignment substantially perpendicular to that edge axis.

4. A system as claimed in claim 2, wherein each tile unit is substantially rectangular in plan view and comprises a plurality of drive motor units arranged in a substantially rectangular shape on the tile unit

5-6. (canceled)

7. A system as claimed in claim 4, wherein opposite pairs of drive motor units are counter-rotated.

8-11. (canceled)

12. A system as claimed in claim 2, further comprising guide wheels located on the edges of adjacent sides of each tile, the axis of rotation of the guide wheels aligned substantially parallel to the adjacent edge, wherein the guide wheels and drive motor unit(s) are arranged so that as the skid plate moves, moving off the point of support provided by a guidewheel or drive motor unit, the skid plate substantially simultaneously moves onto another point of support.

13. A system as claimed in claim 2, further comprising guide wheels located on the edges of adjacent sides of each tile, the axis of rotation of the guide wheels aligned substantially parallel to the adjacent edge, wherein the guide wheels and drive motor unit(s) are arranged so that the support provided to the skid plate is distributed substantially evenly across the underside of the skid plate.

14-16. (canceled)

17. A system as claimed in claim 1, wherein each skid plate comprises a substantially rectangular, substantially rigid item, each skid plate substantially of equal size.

18. A system as claimed in claim 17, wherein each skid plate further comprises wheel guides on the underside of the plate, configured to keep the skid plate aligned with the required axis of movement and to compensate for and correct any misalignment of the plate in use.

19. A system as claimed in claim 1, wherein one or more of the skid plates and tile units further comprises an interlock assembly configured to mutually interlock the skid plate and tile unit when engaged.

20. A system as claimed in claim 19, wherein the interlock assembly comprises at least one depression formed on the upper surface of the skid plate(s), the depression(s) configured to capture the wheel of a payload carrier on the upper surface of the skid plate.

21. A system as claimed in claim 20, wherein the interlock assembly comprises four depressions on the upper surface of the skid plate(s), configured to capture the four wheels of a payload carrier on the upper surface of the skid plate.

22-32. (canceled)

33. A system as claimed in claim 1, further comprising a plurality of corner support elements, each corner support element configured to locate under and support a tile corner, the corner support elements configured for attachment to a supporting surface, each of the corner supports configured to engage with up to four separate tile units.

34. A system as claimed in claim 33, wherein the corner supports are configured so that when the corner support engages with multiple tile units, the corners of directly adjacent tile units are substantially coincident.

35. A system as claimed in claim 33, wherein the corner supports are configured so that the corners of four separate tile units engaged with and supported by the support are substantially coincident.

36-44. (canceled)

45. A system as claimed in claim 1, wherein each tile unit further comprises a cut-out section at two or more corners, the cut-out configured so that a socket is formed at the mutually intersecting corners of any four tile units arranged adjacent to one another with their cut-outs mutually intersecting, each cut-out having a connection section recessed within the socket.

46. A system as claimed in claim 45, further comprising a plug configured to locate into the socket, the plug and socket mutually configured to provide a power connection between adjacent tile units and to allow data and instructions to be exchanged.

47. A system as claimed in claim 1, wherein each tile unit contains one or more of: a wireless transmitter; a power distribution node; a communication distribution system; a safety distribution system; an RFID reader; a set of scales; a barcode scanner.

48-63. (canceled)

64. A system as claimed in claim 3, wherein the at least one rotation motor is arranged to rotate the or each drive motor unit about an axis that intersects the rotational axis of the upwardly-facing wheel of the or each drive motor unit.

65. A tile unit for a system for transporting and/or storing goods within an order processing facility, the tile unit comprising:
a substantially rectangular body having a substantially planar upper surface on which a skid plate can be located, and
a drive means comprising:
at least one drive motor unit comprising an upwardly-facing wheel, the drive unit and the upper surface being configured so that the upwardly-facing wheel extends from the substantially planar upper surface to contact the underside of the skid plate in use such that rotation of the upwardly-facing wheel moves the skid plate across the substantially planar upper surface, and
a rotation motor arranged to rotate the drive motor unit from alignment substantially in parallel with one edge axis of the body to an alignment substantially perpendicular to that edge.

66. The tile unit of claim 65, wherein the rotation motor is arranged to rotate the drive motor unit about an axis that intersects the rotational axis of the upwardly-facing wheel.

67. The tile unit of claim 65, comprising a plurality of drive motor units.

68. The tile unit of claim 67, wherein a pair of the plurality of drive motor units are counter-rotated by the rotation motor.

69. The tile unit of claim 65, further comprising guide wheels located on edges of the tile unit.

70. A skid plate for a system for transporting and/or storing goods within an order processing facility, the skid plate comprising a plate-like body having:
an upper surface configured to receive a payload carrier, and
an underside comprising wheel guides configured to engage drive wheel units of the system for transporting and/or storing goods, the wheel guides acting to keep the skid plate aligned with the required axis of movement and to compensate for and correct any misalignment of the skid plate as the drive wheel units move the skid plate during use.

71. The skid plate of claim 70, wherein the wheel guides comprise grooves formed in the underside of the skid plate to receive a wheel of a drive wheel unit.

72. The skid plate of claim 70, wherein the wheel guides comprise a plurality of crosses.

73. The skid plate of claim 70, wherein the skid plate comprises a substantially rectangular, substantially rigid item.
